(19) United States
(12) Patent Application Publication
(10) Pub. No.: US 2025/0110561 A1
(43) Pub. Date: Apr. 3, 2025

(54) DRIVING SIMULATOR

(71) Applicant: Mississippi State University, Mississippi State, MS (US)

(72) Inventors: J. Adam Jones, Mississippi State, MS (US); Kasee K. Stratton-Gadke, Mississippi State, MS (US); Zaccheus J. Ahonle, Mississippi State, MS (US); Lalitha Dabbiru, Mississippi State, MS (US); Kris Geroux, Madison, MS (US); Woody Neil Watson, II, Starkville, MS (US); Timothy George Stewart, Coldwater, MS (US)

(21) Appl. No.: 18/902,505

(22) Filed: Sep. 30, 2024

Related U.S. Application Data
(60) Provisional application No. 63/586,503, filed on Sep. 29, 2023.

(51) Int. Cl. G06F 3/01; G09B 9/04

(52) U.S. Cl. CPC G06F 3/016; G09B 9/04

(57) ABSTRACT

Methods, systems, and apparatus, including computer programs encoded on a computer storage medium, for implementing a driving simulator are disclosed. In one aspect, a method includes the actions of receiving, by a virtual reality headset, sensor data that reflects characteristics of a user wearing the virtual reality headset. The actions further include, based on the sensor data, determining, by the virtual reality headset, that the user is likely experiencing motion sickness. The actions further include, based on determining that the user is likely experiencing motion sickness, activating, by the virtual reality headset, a vibration device that is configured to provide vibration feedback to a body of the user.

### CROSS-REFERENCE TO RELATED APPLICATION

This application claims the benefit of U.S. Application 63/586,503, filed Sep. 29, 2023, which is incorporated by reference.

### STATEMENT REGARDING FEDERALLY SPONSORED RESEARCH OR DEVELOPMENT

This invention was made with government support under Contract Number 2235863 awarded by the National Science Foundation. The government has certain rights in the invention.

### BACKGROUND

Driving simulators may be used for entertainment and training as part of a driver's education course. They can be used for research purposes, monitoring driver behavior, performance, and attention. Driving simulators may be used in the car industry to design and evaluate new vehicles or new driver assistance systems.

### SUMMARY

An innovative aspect of the subject matter described in this specification may be implemented in a method that includes the actions of receiving, by a virtual reality headset, sensor data that reflects characteristics of a user wearing the virtual reality headset. The actions further include, based on the sensor data, determining, by the virtual reality headset, that the user is likely experiencing motion sickness, also known as simulator sickness or cybersickness. The actions further include, based on determining that the user is likely experiencing motion sickness, activating, by the virtual reality headset, a vibration device that is configured to provide vibration feedback to a body of the user.

Other implementations of this aspect include corresponding systems, apparatus, and computer programs recorded on computer storage devices, each configured to perform the operations of the method.

Another innovative aspect of the subject matter described in this specification may be implemented in controller that is configured to communicate with a driving simulator. The controller may include a first input device that is configured to receive a first type of input from a user and a second input device that is configured to a second type of input from the user. The controller may further include a processor that is configured to receive data indicating a type of disability of the user, and, based on the type of disability of the user, activate the first input device and deactivate the second input device.

Other implementations of this aspect include corresponding methods, apparatus, systems, and computer programs recorded on computer storage devices, each configured to perform the actions of the controller.

Another innovative aspect of the subject matter described in this specification may be implemented in a driving simulator that includes an input device that is configured to receive input from a user and a feedback device that is configured to provide feedback to the user. The driving simulator further includes a virtual reality headset that is configured to receive data indicating a type of disability of the user, and, based on the type of disability of the user, select a driving scenario. The virtual reality headset is further configured to, while executing the driving scenario, receive, via the input device, input from the user. The virtual reality headset is further configured to, while executing the driving scenario and based on the input from the user and the type of disability of the user, provide, to the feedback device, instructions to provide feedback to the user.

Other implementations of this aspect include corresponding methods, apparatus, systems, and computer programs recorded on computer storage devices, each configured to perform the actions of the driving simulator.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates an example system that is configured to prevent a user from experiencing motion sickness while the user is using the virtual reality headset.

FIG. 2 illustrates an example system that is configured to assist a user with a disability in interacting with a driving simulator running on a virtual reality headset.

FIG. 3 is a flowchart of an example process for preventing a user from experiencing motion sickness while the user is using a virtual reality headset.

FIG. 4 illustrates an example computer system.

### DETAILED DESCRIPTION

It should be understood at the outset that although illustrative implementations of one or more implementations are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

A driving simulator may assist a driver or prospective driver in experiencing various road conditions without the risks associated with driving on an actual road. To make a driving simulator more accessible to more people, the driving simulator software may be an application that can be loaded onto a virtual reality headset. The virtual reality headset may communicate with various input devices such as a steering wheel, pedals, turn signals, a gear shifter, and any other type of device to simulate being in a vehicle. While running a driving simulator on a virtual reality headset may make the driving simulator more accessible to more individuals, some may still be unable to take full advantage of the driving simulator. This inability may be because an individual may have certain mental and/or physical conditions that may make it challenging to interact with a conventional driving simulator on a conventional virtual reality headset using conventional input devices.

A condition that the driving simulator described below helps to overcome is the physical condition of motion sickness. Interacting with any virtual world through a virtual reality headset may cause a user to experience motion sickness. In some instances, the solution to overcome motion sickness is to take a break from the driving simulation. The issue with that approach is that sometimes it may not be practical to take a break from driving in the actual world. It would be better to improve the driving simulator so that it can take actions to assist the user in overcoming motion sickness while the user is interacting with the driving simulator. To assist the user in overcoming motion sickness, the driving simulator may receive and analyze various types of sensor data that reflect characteristics of the user, characteristics of the environment of the virtual world, and characteristics of input devices. Based on analyzing the sensor data, the driving simulator may determine whether the user is likely experiencing motion sickness. In response to that determination, the driving simulator may activate various physical feedback devices that are designed to reduce motion sickness. This process may continue as the user drives through the virtual world.

Another condition that the driving simulator described below helps to overcome is any physical disability of the user. Many driving simulators may not include the necessary controls for the various types of physical disabilities that users may have. The driving simulator described below includes multiple types of input devices. For example, the driving simulator may include hand controls for the pedals and traditional pedals. The driving simulator may be configured to activate certain input devices and deactivate other input devices based on a disability of the user. If the driving simulator determines that the user has limited control of the user's legs, then the driving simulator may activate the hand controls for the pedals and deactivate the traditional foot pedals. This may prevent the user from inadvertently interacting with the traditional foot pedals when the user has limited control of the user's legs.

The driving simulator may have the ability to repeat various driving scenarios as needed for the user. Other driving simulators may be limited in the ability of the user to interact with specific situations. For example, for a user to practice merging onto a freeway, the user would have to drive to a virtual freeway and enter the freeway using the onramp. To practice that situation again, the user would have to exit the freeway and navigate back to an onramp. The driving simulator described below has the ability to repeat the same or similar driving situations to provide the user with targeted practice for that situation. For example, if a user has increased anxiety when the user takes an unprotected left turn, then the driving simulator can be loaded with specific driving scenarios that only include unprotected left turns or even the exact same unprotected left turn. As the user practices, the repetition will help to reduce the likelihood of the user experiencing anxiety when actually driving and taking an unprotected left turn.

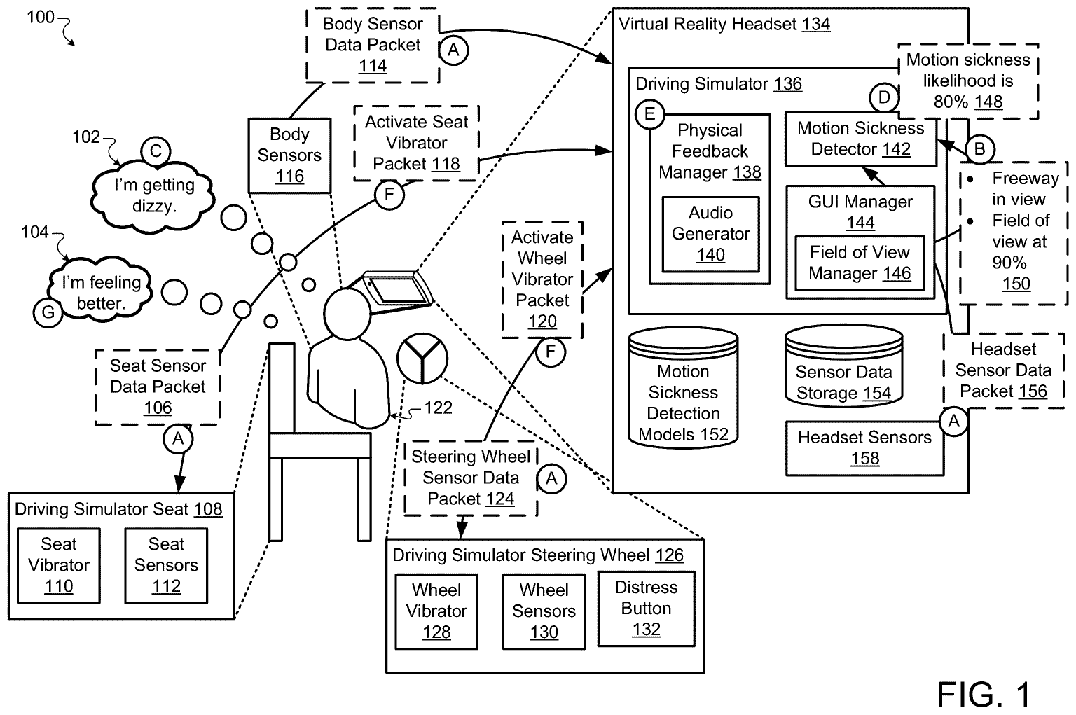

FIG. 1 illustrates an example system 100 that is configured to prevent a user 122 from getting motion sickness while the user 122 is using the virtual reality headset 134. Briefly, and as described in more detail below, the user 122 is wearing the virtual reality headset 134 that is running a driving simulator 136. The driving simulator 136 receives sensor data from various sensors as the user 122 drives through the virtual world. Based on the sensor data and other data sources, the driving simulator 136 may be configured to determine when the user 122 is likely feeling motion sickness. In response, the driving simulator 136 may activate various physical feedback devices to help reduce the likely motion sickness of the user 122. FIG. 1 includes various stages A through G that may illustrate the performance of actions and/or the movement of data between various components of the system 100. The system 100 may perform these stages in any order.

In more detail, the user 122 may be wearing the virtual reality headset 134 and start the driving simulator 136. The driving simulator 136 may be software that the virtual reality headset 134 executes and moves the user 122 through a virtual world as if the user 122 were driving a vehicle. The user 122 may select a driving scenario. Based on the driving scenario, the virtual reality headset 134 may graphical user interface (GUI) manager 144 of the driving simulator 136 may generate a view of a virtual street through the windshield of a vehicle. The GUI manager 144 may present the view of the virtual street on the display of the virtual reality headset 134.

The user 122 may provide input through a driving simulator steering wheel 126 as well as other input devices, such as pedals, hand controls, and any other similar type of input device. The driving simulator steering wheel 126 may include various wheel sensors 130. The wheel sensors 130 may include motion sensors such as an accelerometer, a gyroscope, a gravity detector, and any other similar type of motion sensor. The wheel sensors 130 may also include sensor to detect characteristics of the user 122 such as a pulse monitor, a skin conductance sensor, a blood pressure sensor, a blood oxygen sensor, and any other similar type of body sensor. These sensors may collect data as the user 122 is gripping the steering wheel. The wheel sensors 130 may also include a camera, a microphone, a proximity detector, a light sensor, and any other similar type of sensor.

In stage A as the user 122 is driving through the virtual world, the wheel sensors 130 may generate sensor data. The driving simulator steering wheel 126 may generate a steering wheel sensor data packet 124. The steering wheel sensor data packet 124 may include sensor data collected from the wheel sensors 130 during a period of time, such as the past second. The driving simulator steering wheel 126 may generate and transmit the steering wheel sensor data packet 124 to the virtual reality headset 134 while the user 122 is driving through the virtual world. In some implementations, different wheel sensors 130 may generate and output sensor data at different intervals. For example, the driving simulator steering wheel 126 may include sensor data from the accelerometer, gyroscope, and gravity detector in steering wheel sensor data packets 124 outputted every tenth of a second, hundredth of a second, thousandth of a second, or any other similar frequency. The driving simulator steering wheel 126 may include sensor data from the pulse monitor and skin conductance sensor in steering wheel sensor data packets 124 outputted every three seconds.

While the user 122 is interacting with the driving simulator 136, the user 122 may be sitting in the driving simulator seat 108. The driving simulator seat 108 may include seat sensors 112. Some of the seat sensors 112 may be similar to the wheel sensors 130 and some may be different. For example, the seat sensors 112 may include a pulse monitor, a skin conductance sensor, a blood pressure sensor, a blood oxygen sensor, and any other similar type of body sensor. The seat sensors 112 may also include a camera, a microphone, a proximity detector, a light sensor, a pressure sensor, and any other similar type of sensor. It may not be necessary for the driving simulator seat 108 to include motion sensors such as an accelerometer, a gyroscope, a gravity detector, and any other similar type of motion sensor, but motions sensors may be included anyway in case the driving simulator seat 108 or any portion of it is movable.

In stage A as the user 122 is driving through the virtual world, the seat sensors 112 may generate sensor data. The driving simulator seat 108 may generate a seat sensor data packet 106. The seat sensor data packet 106 may include sensor data collected from the seat sensors 112 during a period of time, such as the past second. The driving simulator seat 108 may generate and transmit the seat sensor data packet 106 to the virtual reality headset 134 while the user 122 is driving through the virtual world. In some implementations, different seat sensors 112 may generate and output sensor data at different intervals. For example, the driving simulator seat 108 may include sensor data from the proximity detector, light sensor, and pressure sensor in seat sensor data packets 106 outputted every tenth of a second. The driving simulator seat 108 may include sensor data from the accelerometer and gravity detector in seat sensor data packets 106 outputted every three seconds.

There may be other sensors that that generate and provide sensor data to the virtual reality headset 134 while the user 122 is driving through the virtual world. These sensors may be similar to the wheel sensors 130 and the seat sensors 112, but may be configured to capture a characteristic of a different element or portion of the environment of the user 122. Body sensors 116 may be attached to the user 122. The body sensors 116 may include a pulse monitor, a skin conductance sensor, a blood pressure sensor, a blood oxygen sensor, a camera, a microphone, a proximity detector, a light sensor, a pressure sensor, an accelerometer, a gyroscope, a gravity detector, and any other similar type of sensor. The body sensors 116 may generate and transmit a body sensor data packet 114 to the virtual reality headset 134 in a similar fashion and frequency as the driving simulator seat 108 and the driving simulator steering wheel 126.

The virtual reality headset 134 may also include built-in headset sensors 158 that are located on the virtual reality headset 134. These sensors may be similar to the wheel sensors 130, the seat sensors 112, and the body sensors 116. The headset sensors 158 may include a pulse monitor, a skin conductance sensor, a blood pressure sensor, a blood oxygen sensor, a camera, a microphone, a proximity detector, a light sensor, a pressure sensor, an accelerometer, a gyroscope, a gravity detector, and any other similar type of sensor. The headset sensors 158 may generate and transmit a headset sensor data packet 156 to the driving simulator 136 in a similar fashion and frequency as the driving simulator seat 108, the driving simulator steering wheel 126, and the body sensors 116.

The virtual reality headset 134 may receive the sensor data packets from these various sources and store the sensor data in the sensor data storage 154. The driving simulator 136 may store the sensor data along with timestamps and data indicating the source of the sensor data in the sensor data storage 154. In some implementations, the driving simulator 136 may store only the most recent portion of the received sensor data from each source or of all sources.

While the user 122 is driving through the virtual world, the GUI manager 144 of the driving simulator 136 may ensure that the display of the virtual reality headset 134 is displaying the proper view. The GUI manager 144 may be implemented by one or more processors that are located on or off the virtual reality headset 134 and that are executing software stored on or off the virtual reality headset 134. The GUI manager 144 may analyze the sensor data stored in the sensor data storage 154 and the sensor data received in real-time to determine how to update the view of the virtual road on the display of the virtual reality headset 134. As the virtual reality headset 134 and the driving simulator 136 receive additional sensor data, the GUI manager 144 may update the display. For example, if the user turns the driving simulator steering wheel 126 to the right, the GUI manager 144 may identify that movement in the steering wheel sensor data packet 124. The GUI manager 144 may update the display of the virtual reality headset 134 to reflect the user 122 turning right.

The GUI manager 144 may also include a field of view manager 146. The field of view manager 146 may be configured to adjust the portion of the display of the virtual reality headset 134 that includes images of the virtual road. For example, the field of view manager 146 may narrow the field of view seen by the user 122 by blacking out the sides of the display. This blacking out may allow the user 122 to focus on the portion of the virtual road that is directly in front of the user 122 and not be distracted by virtual objects off to the side. The field of view manager 146 may increase the field of view by showing additional portions of the virtual road that are off to either side. The field of view manager 146 may adjust the field of view between the range of one hundred percent and a lower percentage range, such as thirty or fifty percent. The percentage may correspond to the amount of the display of the virtual reality headset 134 that is not blacked out.

In stage B, the GUI manager 144 may generate a GUI status packet 150. The GUI status packet 150 may include details related to the contents of the images outputted on the display of the virtual reality headset 134. The details may describe the context of the images, the virtual location, a vehicle that the user 122 is driving, the type of street where the user 122 is driving, the speed of the vehicle, the surroundings including other vehicles and structures, and/or any other similar details. The GUI status packet 150 may also include details related to the field of view percentage of the display of the virtual reality headset 134. As an example, the GUI status packet 150 may indicate that a freeway is displayed on the display of the virtual reality headset 134 and that the field of view is ninety percent.

The GUI manager 144 may provide the GUI status packet 150 to the motion sickness detector 142. The motion sickness detector 142 will be discussed more in detail below with respect to stage D. The GUI manager 144 may provide the GUI status packet 150 to the motion sickness detector 142 on a periodic basis, such as every five seconds or in response to a request from the motion sickness detector 142 or another request source. In some implementations, the GUI manager 144 may initiate providing the GUI status packet 150 to the motion sickness detector 142 in response to a change in the GUI being output. For example, if the field of view changes by at least ten percent, then the GUI manager 144 may generate and provide the GUI status packet 150 to the motion sickness detector 142.

In stage C and as the user 122 is driving through the virtual world, the user 122 may start to feel uncomfortable. The discomfort may be related to motion sickness or a similar type of sickness. The user 122 may have thought 102 that the user 122 is getting dizzy. This thought 102 may be in the head of the user 122. The driving simulator steering wheel 126 may include a distress button 132 that the user 122 can press if the user 122 is in discomfort. However, in this example, the user 122 may not be pressing the distress button 132.

As noted above, the driving simulator 136 may include a motion sickness detector 142. The motion sickness detector 142 may be implemented by one or more processors that are located on or off the virtual reality headset 134 and that are executing software stored on or off the virtual reality headset 134. The motion sickness detector 142 may be configured to analyze the sensor data in the sensor data storage 154 and the GUI status packet 150 and determine a likelihood 148 that the user 122 is experiencing motion sickness. The likelihood 148 that the user 122 is experiencing motion sickness may not be a definitive determinization of whether the user 122 is experiencing motion sickness. Instead, the likelihood 148 may be an estimation determined by the motion sickness detector 142 as to whether the user 122 is experiencing motion sickness.

The motion sickness detector 142 may use the motion sickness detection models 152 to analyze the sensor data in the sensor data storage 154 and the GUI status packet 150. The motion sickness detection models 152 may be trained using one or more machine learning training algorithms. The different types of machine learning algorithms may include a Bayesian algorithm, a decision tree algorithm, a support vector machine (SVM) algorithm, an ensemble of trees algorithm (e.g., random forests and gradient-boosted trees), an artificial neural network, and/or so forth. The motion sickness detection models 152 may be trained using various historical data. The historical data may include data related to previous interactions between various users and various virtual reality headsets. The historical data may be related to interactions with a driving simulator and may include the same type of data as the sensor data in the sensor data storage 154 and the GUI status packet 150. The historical data may also include labels indicating whether the user is experiencing motion sickness. This label may be provided by the user or another source and may be different than a determination made by a driving simulator.

In some implementations, the motion sickness detection models 152 are trained off the virtual reality headset 134. The trained motion sickness detection models 152 may be provided to the virtual reality headset 134. In some implementations, the virtual reality headset 134 may include a model trainer that is configured to train the motion sickness detection models 152. In some implementations, the historical data may also include data related to any type of disability of the previous users. In this case, the motion sickness detector 142 may receive data related to the disability of the user 122 and provide that to the motion sickness detection models 152. In some implementations, the motion sickness detection models 152 may include different models that are configured to analyze sensor data and GUI status packets for user with different types of disabilities. For example, the motion sickness detection models 152 may include models for users in wheelchairs, users with limited use of their arms, users with vision impairments, users with cognitive or mental impairments, and/or any other similar type of disability. In this case, the training data may be grouped according to types of disability. Each group of training data may be used to train a motion sickness detection model.

In some implementations, the motion sickness detection models 152 may include rules-based models. The rules-based models may be deterministic models that are configured to analyze the sensor data in the sensor data storage 154 and GUI status packet 150 in a specific manner such as using various ranges and/or thresholds to compare to the sensor data and the GUI status packet 150.

In stage D, the motion sickness detector 142 may analyze the sensor data in the sensor data storage 154 and GUI status packet 150 and previous GUI status packets. The motion sickness detector 142 may select a model from the motion sickness detection models 152. The selection may be based on the types of data included in the sensor data storage 154 and/or the data included in the GUI status packet 150, a disability of the user 122, and/or any other similar selection choice. The motion sickness detector 142 may provide the sensor data in the sensor data storage 154 and GUI status packet 150 and previous GUI status packets to the selected model. The model may output the likelihood 148 that may indicate that there is an eighty percent likelihood that the user 122 is experiencing motion sickness.

The driving simulator 136 may include a physical feedback manager 138. The physical feedback manager 138 may be implemented on one or more processers located on the virtual reality headset 134 or other devices. The one or more processors may run software stored on or accessible by the virtual reality headset 134. The physical feedback manager 138 may be configured to determine whether to take any action based on the likelihood 148 that the user 122 is experiencing motion sickness. If the physical feedback manager 138 determines to take an action, then the physical feedback manager 138 may determine an action to take that will likely reduce any likely, or possible, motion sickness of the user 122.

The physical feedback manager 138 may be configured to activate various vibrators and other physical feedback devices on the user 122, near the user 122, on the virtual reality headset 134, and/or any other location that may be sensed by the user 122. The driving simulator seat 108 may include various seat vibrators 110. The seat vibrators 110 may be configured to vibrate various portions of the seat 108, such as on the upper of the seat 108, the bottom of the seat 108, and/or any other similar locations. The steering wheel 126 may include various wheel vibrators 128. The wheel vibrators 128 may be configured to vibrate various portions of the steering wheel 126.

The physical feedback manager 138 may activate the various vibrators and other physical feedback devices at different levels. The level of activation may be based on the likelihood that the user is experiencing motion sickness. The level of activation may reflect an intensity of the vibration. For example, the physical feedback manager 138 may instruct the seat vibrator 110 to vibrate at a level four (out of ten levels) based on the likelihood that the user is experiencing motion sickness being eighty percent. As another example, the physical feedback manager 138 may instruct the wheel vibrator 128 to vibrate at a level of seven (out of ten levels) based on the likelihood that the user is experiencing motion sickness being seventy percent.

The physical feedback manager 138 may activate the various vibrators and other physical feedback devices at different timing intervals. The timing intervals may be based on the likelihood that the user is experiencing motion sickness. The timing intervals may reflect the amount of time that the vibrators are active instead of inactive. For example, the physical feedback manager 138 may instruct the seat vibrator 110 to vibrate for one second and be inactive for half a second based on the likelihood that the user is experiencing motion sickness being eighty percent. As another example, the physical feedback manager 138 may instruct the wheel vibrator 128 to vibrate for two seconds and be inactive for three seconds based on the likelihood that the user is experiencing motion sickness being sixty percent.

The physical feedback manager 138 may analyze the likelihood 148 that the user 122 is experiencing motion sickness in addition to other factors. The other factors may be a type of disability of the user 122, the data in the GUI status packet 150, sounds output to a speaker of the virtual reality headset 134 or other devices, and/or any other similar factors. For example, if the user 122 has a type of disability where activating the seat vibrator 110 may increase the anxiety of the user 122, then physical feedback manager 138 may limit activation of the seat vibrator 110. As another example, if the virtual road includes rumble strips and the user 122 is driving over those rumble strips, then the physical feedback manager 138 may activate the seat vibrator 110 and wheel vibrator 128 in a pattern that matches the speed of the virtual vehicle and the size and spacing of the rumble strips.

The physical feedback manager 138 may include an audio generator 140. The audio generator 140 may be configured to generate an audio signal. The audio generator 140 may provide the audio signal to one or more of the vibrators or other physical feedback devices. The audio signal may include timing interval data, activation level data, and/or any other similar type of information used to activate the vibrators. The audio generator 140 may also generate the audio signal based on the audio output to the speaker of the virtual reality headset 134 or other devices, and/or any other similar factors.

The physical feedback manager 138 may also be configured to generate and send instructions to the field of view manager 146 to adjust the field of view of the display of the virtual reality headset 134. The adjustment may be based on the motion sickness likelihood 148 that the user 122 is experiencing motion sickness in addition to other factors. The other factors may be a type of disability of the user 122, the data in the GUI status packet 150, sounds output to a speaker of the virtual reality headset 134 or other devices, and/or any other similar factors. For example, the physical feedback manager 138 may provide instructions to the GUI manager 144 to reduce the field of view to sixty percent if the likelihood 148 of motion sickness is eighty percent. The instructions may include a time period to maintain the change to the field of view and/or a time to revert the field of view to the previous settings.

In stage E, the physical feedback manager 138 may analyze the motion sickness likelihood 148 that the user 122 is experiencing motion sickness, a type of disability of the user 122, the data in the GUI status packet 150 and previous GUI status packets, sounds output to a speaker of the virtual reality headset 134 or other devices, the sensor data stored in the sensor data storage 154, and/or any other similar information. The physical feedback manager 138 may generate vibrator packets for the various vibrators. The vibrator packets may include audio signals that are provided directly to the corresponding vibrators and/or instructions that may be interpreted a processing component of the receiving device, which then activates the corresponding vibrator. The vibrator packets may also include a time period to perform the vibrations and/or a time to cease the vibrations. The vibrator packets may include the activate seat vibrator packet 118 that includes instructions and/or audio signals for the seat vibrator 110. The vibrator packets may include the activate wheel vibrator packet 120 that includes instructions and/or audio signals for the wheel vibrator 128.

In some implementations, the physical feedback manager 138 may take other actions to reduce the likely motion sickness of the user 122. The other actions may include adjusting the speed of texture movement in the graphics displayed on the screen of the virtual reality headset 134 relative to the wireframe of the virtual world. Reducing the speed of the texture movement may reduce the amount of change that the user 122 sees on the screen of the virtual reality headset 134. This change may not necessarily reduce the speed at which the user 122 is moving through the virtual world, rather reduce the graphical changes associated with the movement.

In stage F, the physical feedback manager 138 may transmit the activate seat vibrator packet 118 to the driving simulator seat 108 and the activate wheel vibrator packet 120 to the driving simulator steering wheel 126. The seat vibrator 110 may activate according to the activate seat vibrator packet 118. The wheel vibrator 128 may activate according to the activate wheel vibrator packet 120.

In stage G and after the seat vibrator 110 and wheel vibrator 128 have activated or while they are activating, the user 122 may begin to feel some relief from any motion sickness. In this case, the user may have thought 104 that is the user 122 thinking to himself or herself that the user 122 is feeling better.

After the seat vibrator 110 and wheel vibrator 128 have activated, the sensors, including the body sensors 116, seat sensors 112, and/or the wheel sensors 130 may continue to generate sensor data. The GUI manager 144 may continue to generate GUI status packets 150. The motion sickness detector 142 may continue to analyze the sensor data and the GUI status packets 150. In some instances, the motion sickness detector 142 may continue to determine a likelihood whether the user 122 is experiencing motion sickness. The physical feedback manager 138 may continue to generate and transmit the activate vibrator packets based on the likelihood whether the user 122 is experiencing motion sickness. In some implementations, the physical feedback manager 138 may bypass generating and transmitting activate vibrator packets based on the likelihood that the user 122 is experiencing motion sickness, which is a confidence score, not satisfying a confidence score threshold. For example, if the likelihood that the user 122 is experiencing motion sickness is ten percent and the confidence score threshold is twenty percent, then the physical feedback manager 138 may bypass generating and transmitting activate vibrator packets.

In some implementations, the user 122 may press the distress button 132. This action may initiate the physical feedback manager 138 to generate and transmit activate vibrator packets to the various physical feedback devices. The positive identification of the distress may also be used to update and retrain the motion sickness detection models 152. The positive identification of the distress along with the corresponding sensor data, GUI data, other information related to the user 122 may be used to iteratively retrain the motion sickness detection models 152. In some implementations, the virtual reality headset 134 may request that the user 122 provide feedback as to whether the user 122 is feeling motion sickness. The virtual reality headset 134 may provide the feedback from the user 122 along with the corresponding sensor data, GUI data, other information related to the user 122 to the model trainer. The model trainer may iteratively retrain the motion sickness detection models 152 with this new information.

In some implementations, the user 122 can manually activate the seat vibrator 110, wheel vibrator 128 and/or other feedback devices. The activation can take various forms. In one case, the user 122 can provide an instruction to the driving simulator 136 so the seat vibrator 110, wheel vibrator 128 and/or other feedback devices provide feedback that is in line with the current characteristics of the virtual world in which the user is driving. These characteristics may include what the user 122 is viewing on the display of the virtual reality headset 134, the audio output by the virtual reality headset 134, the physical characteristics of the virtual world, and/or any other similar characteristics. The physical characteristics of the virtual world may include the texture of the road, the speed of the car, the type of car, the wind, the type of tires on the car, the engine speed, the gear of the car, and/or any other similar characteristic. In another case, the user 122 can provide an instruction to the driving simulator 136 so the seat vibrator 110, wheel vibrator 128 and/or other feedback devices provide constant or steady feedback while the user is driving through the virtual world.

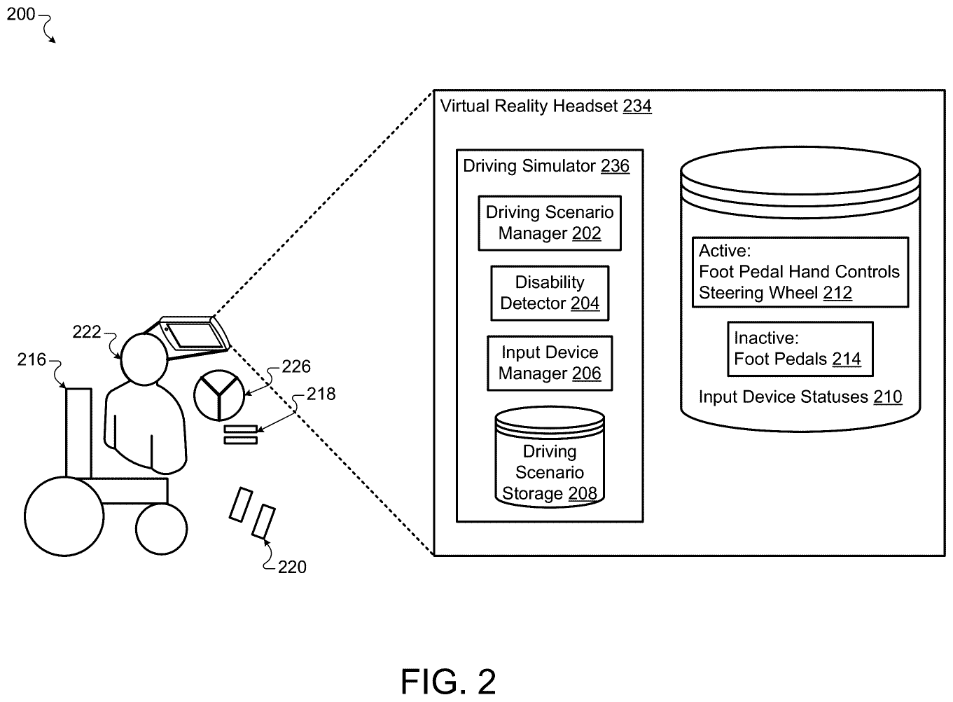

FIG. 2 illustrates an example system 200 that is configured to assist a user 222 with a disability in interacting with a driving simulator 236 running on a virtual reality headset 234. The virtual reality headset 234 may be similar to the virtual reality headset 134 of FIG. 1. The virtual reality headset 134 and virtual reality headset 234 may each highlight different components of the same virtual reality headset. Any virtual reality headset that a user wears while engaging with a driving simulator may have components included in either or both of the virtual reality headset 134 and virtual reality headset 234.

Similar to the virtual reality headset 134 of FIG. 1, the virtual reality headset 234 may be configured to provide users, even those with varying types of physical and mental disabilities, the ability to interact with a driving simulator 236. The virtual reality headset 234 may interact with various input devices. The inputs devices may allow the user 222 to provide input to the driving virtual reality headset 234. The input devices may be similar to those used by various users with different types of physical and intellectual disabilities. Some of the input devices may be used by users who do not have any type of physical or intellectual disabilities. For example, the input devices may include a steering wheel 226. The steering wheel 226 may be similar to the driving simulator steering wheel 126 of FIG. 1. The input devices may also include foot pedals 220 that may be configured to accelerate and slow down the virtual vehicle. The input devices may also include hand controls that are configured to accelerate and slow down the virtual vehicle. Other types of input devices such as headlight controls, blinker controls, radio controls, climate controls, gear shift, clutch, parking brake, and/or other types of input devices may be included as well. Some of the devices designed for users who do not have any type of physical or intellectual disabilities may have counterpart versions for those users with different types of physical and intellectual disabilities.

The input devices may also include feedback devices. The feedback devices may be configured to provide physical, audio, and/or visual feedback to the user 222. In some implementations, the feedback devices may be included in the input devices. For example, the steering wheel 226 may include a vibrator and a speaker. The hand controls 218 may include a vibrator. Other feedback devices may be included in the virtual reality headset 234 and/or may be attached to other objects in or around the user 222. For example, the wheelchair 216 may include a vibrator.

The driving simulator 236 may include a driving scenario manager 202. The driving scenario manager 202 may be implemented by one or more processors that are located on or accessible by the virtual reality headset 234 running software stored on or accessible by the virtual reality headset 234. The driving scenario manager 202 may be configured to access the driving scenarios in the driving scenario storage 208 and select a driving scenario. The driving scenario manager 202 may load and present the selected driving scenario to the user 222 through the display of the virtual reality headset 234.

A driving scenario may include a virtual location, surrounding traffic, various environmental conditions, vehicle types, and/or a task for the user 222 to accomplish in the virtual world. An example driving scenario may present the user with a left turn from a shared left turn lane, a left turn from a turning bay, a protected left turn at a stoplight, an unprotected left turn at a stoplight. Another example scenario may present the user with entering and exiting various freeways with different lengths of merging lanes. Some scenarios may only include one situation, such as driving down a portion of a freeway in a sport utility vehicle.

The driving simulator 236 may include a disability detector 204. The disability detector 204 may be implemented by one or more processors that are located on or accessible by the virtual reality headset 234 running software stored on or accessible by the virtual reality headset 234. The disability detector 204 may be configured to receive data indicating whether the user 222 is disabled and what type of disability the user 222 may have. In some implementations, the disability detector 204 may be configured to analyze various types of data and determine whether the user 222 has a disability. The disability detector 204 may also be configured to determine a likely disability of the user 222 in the case where the disability detector determines that the user 222 likely has a disability.

The disability detector 204 may be configured to analyze sensor data from various sensors on the various input devices, on the body of the user 222, on the virtual reality headset 234, and/or any other nearby location. The sensors may be similar to other sensors described above and below. In some implementations, the disability detector 204 may provide the sensor data to a model trained on historical data using one of the machine learning algorithms described above. The historical data may include sensor data collected from various users and data identifying whether the corresponding user has a disability and, if so, the type of disability that the corresponding user has.

In some implementations, the disability detector 204 may be configured to analyze image data collected from the various cameras on and around the virtual reality headset 234. Some of the images may capture the user 222 and the wheelchair 216. The disability detector 204 may use computer vision techniques to identify the wheelchair 216 and determine that the user 222 has a disability that prevents the user 222 from having full use of the legs of the user 222.

The driving scenario manager 202 may be configured to use the disability identified by the disability detector 204 to select a driving scenario from the driving scenario storage 208. The driving scenario manager 202 may select a driving scenario based on types of scenarios that users with the identified disability have historically had difficulty performing. For example, users who are unable to use their legs may need to practice driving scenarios related to turning. With this type of practice, the user may improve their ability to turn the steering wheel 226 and operate the hand controls 218 at the same time.

In some implementations, the driving scenario manager 202 may be configured to present multiple driving scenarios to the user 222 in a sequential fashion. While the driving scenario manager 202 is presenting the multiple driving scenarios, the driving scenario manager 202 may receive and analyze sensor data collected from the various sensors that are communicating with the virtual reality headset 234. The driving scenario manager 202 may also analyze the performance of the user 222 during the different types of driving scenarios. Based on this analysis, the driving scenario manager 202 determine which driving scenarios performed below a threshold performance level and/or which driving scenarios likely caused the user 222 anxiety, nervousness, and/or any other similar feeling.

The driving scenario manager 202 may analyze the sensor data and/or performance-related data using various models that may be configured to determine whether the user 222 is likely feeling anxious, nervous, and/or any other similar feeling. The driving scenario manager 202 may provide the sensor data and/or performance-related data to a model that is trained using historical data that includes previous sensor data and/or previous performance-related data along with labels indicating the feelings of the corresponding user, such as anxiety, nervousness, and/or any other similar feeling. The model may be trained using any of the machine learning algorithms described above. Based on the likelihood that the user 222 is feeling anxious/nervous/etc. and/or the performance level of the user 222, the driving scenario manager 202 may repeat any of the driving scenarios in the driving scenario storage 208 until the user 222 appears to be comfortable with any of the driving scenarios as based on subsequent analyses performed using the models.

In some implementations, the user 222 may provide feedback indicating whether the user 222 felt anxious/nervous/etc. In this case, the driving scenario manager 202 may provide the corresponding sensor data and/or performance-related data to the model trainer along with the user feedback. The model trainer may iteratively retrain the models using the new data and one of the machine learning algorithms. The model trainer may provide the retrained model to the virtual reality headset 234 to analyze subsequent sensor data.

In some implementations, the user 222 or another source may specifically request particular diving scenarios and a number of times to present the requested driving scenarios. In this case, the driving scenario manager 202 may present the driving scenarios as requested by the user 222 or the other source.

As the driving simulator 236 is presenting the selected driving scenario, the driving simulator 236 may update the display of the virtual reality headset 234 in response to the inputs received from the input controls. The driving simulator 236 may also determine how to provide feedback to the user 222 during the driving scenario. The driving simulator 236 may make this determination based on the disability or likely disability of user 222. For example, the driving simulator 236 may bypass providing feedback, such as physical feedback, to the bottom of a chair if the user 222 is unable to feel below the waist. As another example, the driving simulator 236 may determine to provide feedback, such as physical feedback, to the user 222 through the steering wheel 226 and/or hand controls 218 if the user 222 has use of the arms of the user 222.

The driving simulator 236 may include an input device manager 206. The input device manager 206 may be implemented by one or more processors that are located on or accessible by the virtual reality headset 234 running software stored on or accessible by the virtual reality headset 234. The input device manager 206 may be configured to activate and deactivate various input controls for the driving simulator 236 based on the disability or likely disability of user 222. The input device manager 206 may also use the selected driving scenario as a factor in determining which input controls to activate and deactivate.

As an example, the disability detector 204 may determine that the user is in a wheelchair 216 and is unable to use the user's legs. The driving scenario manager 202 may select a driving scenario that is focused on making right and left turns. The input device manager 206 analyzes the selected driving scenario and the physical and/or mental disabilities of the user 222. Based on that analysis, the input device manager 206 may update the input device statuses 210. The input device manager 206 may specify that the active devices 212 may include the foot pedal hand controls 218 and the steering wheel 226. The input device manager 206 may specify that the inactive devices 214 are the foot pedals 220. With the input device manger 206, the driving similar 236 is able to provide custom controls to the user 222 based on any disability of the user and/or the selected driving scenario. If needed, the user 222 may override the selections of the input device manager 206.

In some implementations, the disability detector 204 may receive input directly from the user 222 and/or another user, such as an instructor, that indicates the disability of the user 222. The disability detector 204 may provide data indicating the disability to the driving scenario manager 202. The driving scenario manager 202 can select and manage the driving scenarios presented to the user 222 based on the provided disability information. In some instances, the provided disability information may override any disability identified by the disability detector 204.

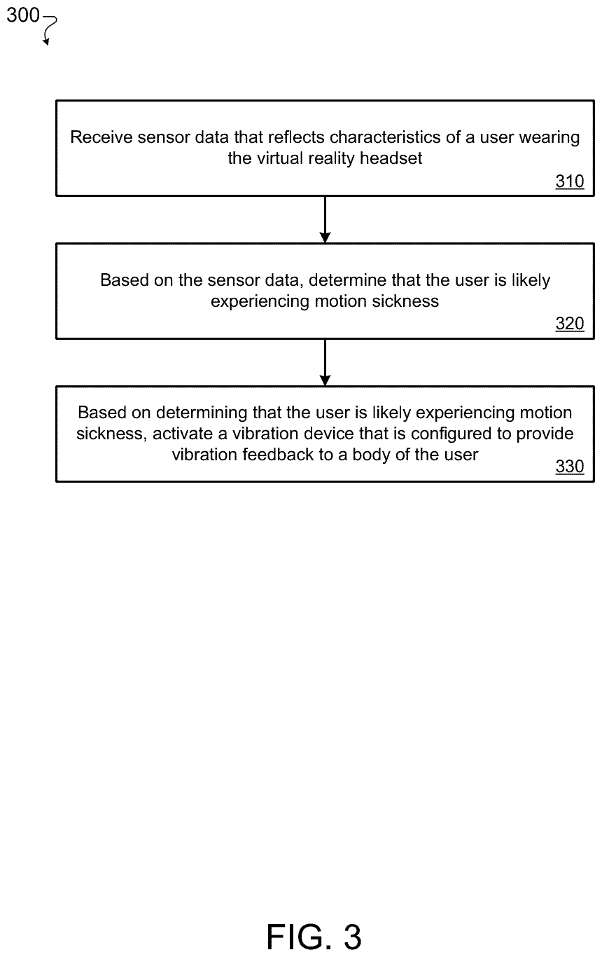

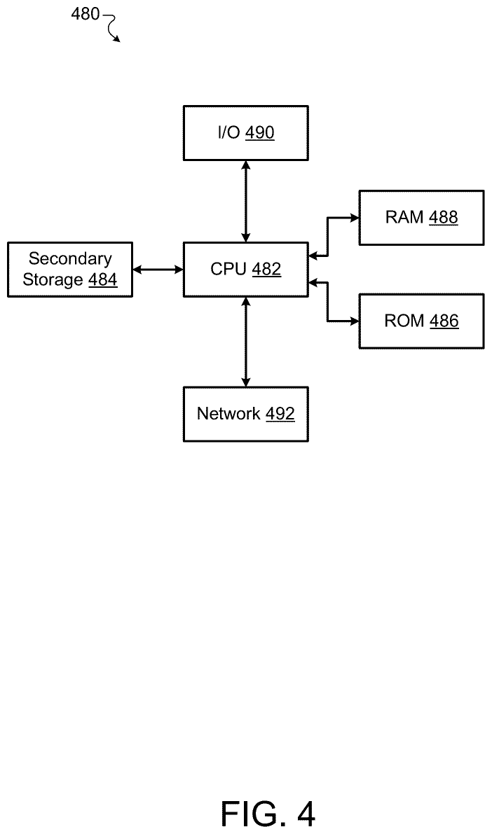

FIG. 3 is a flowchart of an example process 300 for preventing a user from getting motion sickness while the user is using a virtual reality headset. In general, the process 300 receives sensor data related to the user. Based on the sensor data, the process 300 determines whether the user is likely experiencing motion sickness. Based on that determination, the process 300 determines whether to activate a vibration device that is configured to reduce the likelihood that the user is experiencing motion sickness. The process 300 will be described as being performed by the virtual reality headset 134 and will include references to other components in FIG. 1. In some implementations, the process 300 may be performed by the virtual reality headset 234 of FIG. 2 and/or the system 480 of FIG. 4, which is discussed below. The process 300 may be performed by a single computing device, which may be a virtual device and/or split across multiple computing devices that may include virtual devices. In some implementations, the process 300 may be performed by an application that is running on the virtual reality headset 134.

The virtual reality headset 134 receives sensor data that reflects characteristics of a user 122 wearing the virtual reality headset 134 (310). In some implementations, the sensor data is received from a head position sensor, a gaze direction sensor, an eye tracking sensor, a gravity sensor, a skin conductance sensor, an accelerometer, a proximity sensor, a light sensor, a camera, and a microphone. These sensors may be included in the virtual reality headset 134, attached to the body of the user, included in objects that the user 122 is interacting with, and/or any other similar locations. In some implantations, the virtual reality headset 134 may be executing a driving simulator with which the user 122 is interacting.

Based on the sensor data, the virtual reality headset 134 determines that the user 122 is likely experiencing motion sickness (320). In some implementations, the virtual reality headset 134 provides the sensor data and any additional data to a model that is trained using sensor data and other additional data from previous users and labels indicating whether the previous users were experiencing motion sickness while interacting with a driving simulator. The model may output data indicating whether the user 122 is likely experiencing motion sickness. The model may also output a confidence score that indicates the likelihood that the user 122 is experiencing motion sickness.

In some implementations, the virtual reality headset 134 determines that the user 122 is likely experiencing motion sickness based further on graphics being displayed on a screen of the virtual reality headset 134. In some implementations, the virtual reality headset 134 determines that the user 122 is likely experiencing motion sickness based further on a field of view or a narrowing or widening in the field of view of graphics being displayed on a screen of the virtual reality headset 134. In some implementations, the virtual reality headset 134 may also use audio output by the virtual reality headset 134 to determine whether the user 122 is likely experiencing motion sickness. In some implementations, the virtual reality headset 134 determines that the user 122 is likely experiencing motion sickness based further on the user directly providing information indicating that the user 122 is experiencing motion sickness. For example, the user 122 may press a distress button to indicate the user 122 is feeling motion sickness.

Based on determining that the user is likely experiencing motion sickness, the virtual reality headset 134 activates a vibration device that is configured to provide vibration feedback to a body of the user (330). In some implementations, the virtual reality headset 134 generates an electrical signal and provides the electrical signal to the vibration device. The electrical signal may be a type of audio signal that is provided directly to the vibration device. The electrical signal may be instructions to be interpreted by a processing device that then provides input, directly or indirectly, to the vibration device.

In some implementations, the virtual reality headset 134 adjusts a field of view of the graphics being displayed on the screen of the virtual reality headset based on determining that the user is likely experiencing motion sickness. For example, the virtual reality headset 134 may decrease the field of view to assist the user in overcoming the likely motion sickness.

In some implementations, the user 122 may provide data confirming whether the user 122 was or was not experiencing motion sickness. The virtual reality headset 134 may output this confirmation data along with the data inputted into the model to the device that trained the model. The device may iteratively retrain the model using a similar technique or algorithm to the one originally used to train the model. The model trainer may provide the retrained model to the virtual reality headset 134 for use in subsequent analyses.

In some implementations, the virtual reality headset 134 may continue the process of receiving sensor data, analyzing the sensor data, and determining whether the user is likely experiencing motion sickness after activating the vibration device. If the virtual reality headset 134 determines that the user 122 is likely not continuing to experience motion sickness, then the virtual reality headset 134 may deactivate the vibration device or cease performing any other action designed to reduce the possible motion sickness. If the virtual reality headset 134 determines that the user 122 is likely continuing to experience motion sickness, then the virtual reality headset 134 may increase a vibration level of the vibration device, adjust the frequency that the vibration device vibrates at, instruct a different vibration device to vibrate, adjusting a field of view of the screen of the virtual reality headset 134, and/or any other similar adjustment.

FIG. 4 illustrates an example computer system 480 suitable for implementing one or more implementations disclosed herein. The computer system 480 includes a processor 482 (which may be referred to as a central processor unit or CPU) that is in communication with memory devices including secondary storage 484, read only memory (ROM) 486, random access memory (RAM) 488, input/output (I/O) devices 490, and network connectivity devices 492. The processor 482 may be implemented as one or more CPU chips.

It is understood that by programming and/or loading executable instructions onto the computer system 480, at least one of the CPU 482, the RAM 488, and the ROM 486 are changed, transforming the computer system 480 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 480 is turned on or booted, the CPU 482 may execute a computer program or application. For example, the CPU 482 may execute software or firmware stored in the ROM 486 or stored in the RAM 488. In some cases, on boot and/or when the application is initiated, the CPU 482 may copy the application or portions of the application from the secondary storage 484 to the RAM 488 or to memory space within the CPU 482 itself, and the CPU 482 may then execute instructions that the application is comprised of. In some cases, the CPU 482 may copy the application or portions of the application from memory accessed via the network connectivity devices 492 or via the input/output (I/O) devices 490 to the RAM 488 or to memory space within the CPU 482, and the CPU 482 may then execute instructions that the application is comprised of. During execution, an application may load instructions into the CPU 482, for example load some of the instructions of the application into a cache of the CPU 482. In some contexts, an application that is executed may be said to configure the CPU 482 to do something, e.g., to configure the CPU 482 to perform the function or functions promoted by the subject application. When the CPU 482 is configured in this way by the application, the CPU 482 becomes a specific purpose computer or a specific purpose machine.

The secondary storage 484 is typically comprised of one or more disk drives or tape drives and is used for non-volatile storage of data and as an over-flow data storage device if RAM 488 is not large enough to hold all working data. Secondary storage 484 may be used to store programs which are loaded into RAM 488 when such programs are selected for execution. The ROM 486 is used to store instructions and perhaps data which are read during program execution. ROM 486 is a non-volatile memory device which typically has a small memory capacity relative to the larger memory capacity of secondary storage 484. The RAM 488 is used to store volatile data and perhaps to store instructions. Access to both ROM 486 and RAM 488 is typically faster than to secondary storage 484. The secondary storage 484, the RAM 488, and/or the ROM 486 may be referred to in some contexts as computer readable storage media and/or non-transitory computer readable media.

I/O devices 490 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 492 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 492 may provide wired communication links and/or wireless communication links (e.g., a first network connectivity device 492 may provide a wired communication link and a second network connectivity device 492 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In some implementations, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and/or radio frequency identity (RFID). The radio transceiver cards may promote radio communications using 5G, 5G New Radio, or 5G LTE radio communication protocols. These network connectivity devices 492 may enable the processor 482 to communicate with the Internet or one or more intranets. With such a network connection, it is contemplated that the processor 482 might receive information from the network, or might output information to the network in the course of performing the above-described method steps. Such information, which is often represented as a sequence of instructions to be executed using processor 482, may be received from and outputted to the network, for example, in the form of a computer data signal embodied in a carrier wave.

Such information, which may include data or instructions to be executed using processor 482 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 482 executes instructions, codes, computer programs, scripts which it accesses from hard disk, floppy disk, optical disk (these various disk-based systems may all be considered secondary storage 484), flash drive, ROM 486, RAM 488, or the network connectivity devices 492. While only one processor 482 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 484, for example, hard drives, floppy disks, optical disks, and/or other device, the ROM 486, and/or the RAM 488 may be referred to in some contexts as non-transitory instructions and/or non-transitory information.

In some implementations, the computer system 480 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In some implementations, virtualization software may be employed by the computer system 480 to provide the functionality of a number of servers that is not directly bound to the number of computers in the computer system 480. For example, virtualization software may provide twenty virtual servers on four physical computers. In some implementations, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In some implementations, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 480, at least portions of the contents of the computer program product to the secondary storage 484, to the ROM 486, to the RAM 488, and/or to other non-volatile memory and volatile memory of the computer system 480. The processor 482 may process the executable instructions and/or data structures in part by directly accessing the computer program product, for example by reading from a CD-ROM disk inserted into a disk drive peripheral of the computer system 480. Alternatively, the processor 482 may process the executable instructions and/or data structures by remotely accessing the computer program product, for example by downloading the executable instructions and/or data structures from a remote server through the network connectivity devices 492. The computer program product may comprise instructions that promote the loading and/or copying of data, data structures, files, and/or executable instructions to the secondary storage 484, to the ROM 486, to the RAM 488, and/or to other non-volatile memory and volatile memory of the computer system 480.

In some contexts, the secondary storage 484, the ROM 486, and the RAM 488 may be referred to as a non-transitory computer readable medium or a computer readable storage media. A dynamic RAM implementation of the RAM 488, likewise, may be referred to as a non-transitory computer readable medium in that while the dynamic RAM receives electrical power and is operated in accordance with its design, for example during a period of time during which the computer system 480 is turned on and operational, the dynamic RAM stores information that is written to it. Similarly, the processor 482 may comprise an internal RAM, an internal ROM, a cache memory, and/or other internal non-transitory storage blocks, sections, or components that may be referred to in some contexts as non-transitory computer readable media or computer readable storage media.

While several implementations have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various implementations as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A computer-implemented method, comprising:
receiving, by a virtual reality headset, sensor data that reflects characteristics of a user wearing the virtual reality headset;
based on the sensor data, determining, by the virtual reality headset, that the user is likely experiencing motion sickness; and
based on determining that the user is likely experiencing motion sickness, activating, by the virtual reality headset, a vibration device that is configured to provide vibration feedback to a body of the user.

2. The method of claim 1, wherein activating the vibration device comprises:
based on the sensor data, generating, by the virtual reality headset, an electrical signal; and
providing, by the virtual reality headset and to the vibration device, the electrical signal.

3. The method of claim 2, wherein the electrical signal is an audio signal.

4. The method of claim 1, wherein the sensor data is received from a head position sensor, a gaze direction sensor, an eye tracking sensor, a gravity sensor, a skin conductance sensor, an accelerometer, a proximity sensor, a light sensor, a camera, and a microphone.

5. The method of claim 1, wherein determining that the user is likely experiencing motion sickness comprises:
providing, to a model that is trained using previous sensor data and previous data indicating that previous users are experiencing motion sickness, the sensor data; and
receiving, from the model, data indicating that the user is likely experiencing motion sickness.

6. The method of claim 1, comprising:
receiving, by the virtual reality headset and from the user, data indicating whether the user is experiencing motion sickness; and
providing, for output by the virtual reality headset, the data indicating whether the user is experiencing motion sickness, the sensor data, and data indicating that the user is likely experiencing motion sickness.

7. The method of claim 1, wherein the virtual reality headset is executing diving simulation software.

8. The method of claim 1, wherein determining that the user is likely experiencing motion sickness is further based on graphics being displayed on a screen of the virtual reality headset.

9. The method of claim 1, wherein determining that the user is likely experiencing motion sickness is further based on a field of view or a narrowing or widening in the field of view of graphics being displayed on a screen of the virtual reality headset.

10. The method of claim 1, comprising:
after activating the vibration device, receiving, by the virtual reality headset, additional sensor data that reflects the characteristics of the user wearing the virtual reality headset;
based on the additional sensor data, determining, by the virtual reality headset, that the user is continuing to likely experience motion sickness; and
based on determining that the user is continuing to likely experiencing motion sickness:
adjusting, by the virtual reality headset, a vibration level of the vibration device; and
activating, by the virtual reality headset, an additional vibration device that is configured to provide additional vibration feedback to the body of the user.

11. The method of claim 1, comprising:
based on determining that the user is likely experiencing motion sickness, adjusting, by the virtual reality headset, a field of view of graphics being displayed on a screen of the virtual reality headset.

12. The method of claim 1, comprising:
receiving, by the virtual reality headset and from the user, data indicating whether the user is experiencing motion sickness,
wherein determining that the user is likely experiencing motion sickness is further based on the data indicating whether the user is experiencing motion sickness.

13. A driving simulator, comprising:
an input device that is configured to receive input from a user;
a feedback device that is configured to provide feedback to the user;
a virtual reality headset that is configured to:
receive data indicating a type of disability of the user;
based on the type of disability of the user, select a driving scenario;
execute the driving scenario; and
while executing the driving scenario:
receive, via the input device, input from the user; and
based on the input from the user and the type of disability of the user, provide, to the feedback device, instructions to provide feedback to the user.

14. The driving simulator of claim 13, wherein the input device comprises a steering device or a hand control for a throttle or a brake input.

15. The driving simulator of claim 13, wherein the feedback device is a vibration device that is configured to provide vibration feedback to a body of the user.

16. The driving simulator of claim 13, wherein the virtual reality headset is configured to:
after executing the driving scenario, determine whether to repeat the driving scenario based on the type of disability of the user.

17. A controller that is configured to communicate with a driving simulator, comprising:
a first input device that is configured to receive a first type of input from a user;
a second input device that is configured to a second type of input from the user;
a processor that is configured to:
receive data indicating a type of disability of the user; and
based on the type of disability of the user, activate the first input device and deactivate the second input device.

18. The controller of claim 17, wherein the first input device and the second input device are selected from a hand or foot control for a brake input or throttle, a steering device, and a control for a vehicle accessory.

19. The controller of claim 17, wherein the first input device and the second input device are configured to connect to a wheelchair.

20. The controller of claim 17, comprising:
a first feedback device that is configured to provide a first type of feedback to the user; and
a second feedback device that is configured to provide a second type of feedback to the user,
wherein the processor is configured to:
facilitate communication between the first feedback device and the driving simulator, based on the type of disability of the user; and
block communication between the second feedback device and the driving simulator, based on the type of disability of the user.
